(19) United States
(12) Patent Application Publication
(10) Pub. No.: US 2008/0170571 A1
(43) Pub. Date: Jul. 17, 2008

(54) Method and System for Synchronous Page Addressing in a Data Packet Switch

(75) Inventors: Dhiraj Kumar, Morristown, NJ (US); Kanwar Jit Singh, Panchkula (IN)

Correspondence Address: MCDONNELL BOEHNEN HULBERT & BERGHOFF, LLP, 300 SOUTH WACKER DRIVE, CHICAGO, IL, 60606, US

(73) Assignee: UTSTARCOM, INC.

(21) Appl. No.: 11/622,699

(22) Filed: Jan. 12, 2007

(51) Int. Cl. H04L 12/56

(52) U.S. Cl. 370/392; 370/386; 370/412

(57) ABSTRACT

A method and system for synchronous page addressing in a data packet switch is provided. Within the packet switch, separate devices are responsible for storing a portion of a received data packet, and thus a view of used memory addresses seen by one device matches that seen by the others. Each device uses the same order of memory addresses to write data so that bytes of data are stored as a linked-list of pages. Maintaining the same sequence of page requests and sequence of free-page addresses to which to write these pages ensures consistent addressing of the portions of the data packet.

### FIELD OF INVENTION

The present invention relates to processing data packets at a packet switch (or router) in a packet switched communications network, and more particularly, to a method of storing or buffering data packets using multiple devices.

### BACKGROUND

A switch within a data network receives data packets from the network via multiple physical ports, and processes each data packet primarily to determine on which outgoing port the packet should be forwarded. In a packet switch, a line card is typically responsible for receiving packets from the network, processing and buffering the packets, and transmitting the packets back to the network. In some packet switches, multiple line cards are present and interconnected via a switch fabric, which can route packets from one line card to another. On a line card, the direction of packet flow from network ports toward the switch fabric is referred to as “ingress”, and the direction of packet flow from the switch fabric toward the network ports is referred to as “egress”.

In the ingress direction of a typical line card in a packet switch, a packet received from the network is first processed by an ingress header processor, then stored in external memory by an ingress buffer manager, and then scheduled for transmission across the switch fabric by an ingress traffic manager. In the egress direction, a packet received from the switch fabric at a line card is processed by an egress header processor, stored in external memory by an egress buffer manager, and then scheduled for transmission to a network port by an egress traffic manager.

In packet switches where bandwidth requirements are high, it is common for the aggregate bandwidth of all the incoming ports to exceed the feasible bandwidth of an individual device used for buffer management. In such cases, the buffer managers typically include multiple devices to achieve the required bandwidth. The aggregate input bandwidth can be split between multiple devices in the ingress buffer manager by dividing the number of incoming ports evenly among the number of buffer manager devices. However, when there is a single high-speed incoming interface from the network to the packet switch, it can become more difficult to split the incoming bandwidth among the multiple buffering devices.

One method by which incoming bandwidth from a single high speed port is split over multiple buffering devices in a packet switch is through inverse multiplexing. Inverse multiplexing will send some packets to each of the available buffering devices in the packet switch in a load-balancing manner. For example, inverse multiplexing speeds up data transmission by dividing a data stream into multiple concurrent streams that are transmitted at the same time across separate channels to available buffering devices, and are then reconstructed at the port interface into the original data stream for transmission back into the network.

Unfortunately, however, existing techniques used to decide which packets should be sent to which buffering device have some disadvantages. For example, if some packets from a particular flow are sent to one buffering device, and other packets from the same flow are sent to another buffering device, then data packets will likely arrive out of order at their final destination. This requires data packet re-ordering at the destination, which adds implementation complexity if the re-ordering is accomplished at high rate incoming interfaces (such as 40 Gb/s). On the other hand, if some flow identification is used so that data packets from a certain flow are always sent to the same buffering device, then it becomes difficult to evenly balance the bandwidth among the available buffering devices. Such load balancing imperfections typically lead to performance loss.

Ultimately, some technique for dividing received packets among the multiple buffering devices is probably used. When a packet is stored on multiple devices, a way of addressing the packet is needed so that each device can access the appropriate memory. For example, the address of the packet in each device can be concatenated and treated as a reference for the packet. However, a means of synchronizing multiple buffering engines is still needed.

### SUMMARY

Within embodiments disclosed herein, a packet switch is provided that includes a port interface module, memory modules and buffer manager devices. The port interface module receive a data packet, and divides the data packet into n portions, such that each subsequent portion includes every subsequent nth group of the data packet. The buffer manager devices are coupled to the port interface module and each buffer manager device is also coupled to a respective memory module. Each buffer manager device receives at least one of the n portions of the data packet from the port interface module and stores the portion at a location in the respective memory module to which the buffer manager device is coupled using the same order of memory addresses so as to store the received portions of the data packet in a synchronized manner.

In another embodiment, a method for storing data packets received at a packet switch is provided. The method includes receiving a data packet into a port interface module of the packet switch and dividing the data packet into multiple portions. The method also includes sending the multiple portions of the data packet to buffer manager devices and each buffer manager device stores data in a respective memory that has multiple channels to which to write data. A given buffer manager device will inform the other buffer manager devices of a memory address to which to write data on a given channel in memory and each buffer manager device stores received portions of the data packet at the memory address of the given channel in the buffer manager device's respective memory.

In still another embodiment, a method for storing data packets received at a packet switch is provided. The method includes receiving a data packet into a port interface module of the packet switch and dividing the data packet into multiple portions. The method also includes sending the multiple portions of the data packet to buffer manager devices and each buffer manager device stores data in a respective memory having multiple channels to which to write data. The method further includes each buffer manager device maintaining addressing of one memory channel and utilizing a ring transmission technique to indicate memory address information to which to write data for each memory channel between the buffer manager devices so that each buffer manager device stores received portions of the data packet in the memory channel at the indicated memory address within the buffer manager device's respective memory.

These as well as other features, advantages and alternatives will become apparent to those of ordinary skill in the art by reading the following detailed description, with appropriate reference to the accompanying drawings.

### BRIEF DESCRIPTION OF FIGURES

FIG. 1 is a block diagram illustrating one embodiment of a communication network.

FIG. 2 is a block diagram illustrating one example of a packet switch.

FIG. 3 is a detailed block diagram illustrating an example of a packet switch using multiple buffering managers to implement the buffering engine.

FIG. 4 illustrates an example timing diagram demonstrating one example of a CRC protection that may be used by the buffer managers.

FIG. 5 is an example diagram illustrating page addressing to be used for storing bytes of a received data packet within the buffer managers.

FIG. 6 is an example messaging diagram illustrating communications between each buffer manager.

FIG. 7 illustrates an example two counter-rotating ring that can be used to transmit messages and acknowledgments between the buffer managers.

FIGS. 8A and 8B illustrate examples of dividing received data packets for storage within memory as directed by the buffer managers.

### DETAILED DESCRIPTION

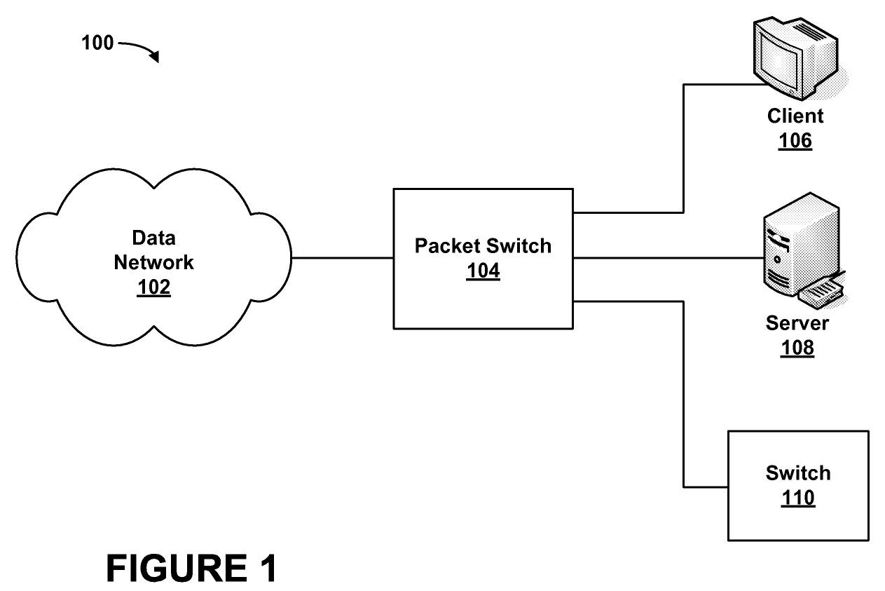

Referring now to the figures, and more particularly to FIG. 1, one embodiment of a communication network 100 is illustrated. It should be understood that the communication network 100 illustrated in FIG. 1 and other arrangements described herein are set forth for purposes of example only, and other arrangements and elements can be used instead and some elements may be omitted altogether, depending on manufacturing and/or consumer preferences.

By way of example, the network 100 includes a data network 102 coupled via a packet switch 104 to a client device 106, a server 108 and a switch 110. The network 100 provides for communication between computers and computing devices, and may be a local area network (LAN), a wide area network (WAN), an Internet Protocol (IP) network or some combination thereof.

The packet switch 104 receives data packets from the data network 102 via multiple physical ports, and processes each individual packet to determine to which outgoing port the packet should be forwarded, and thus to which device (e.g., client 106, server 108 or switch 110) the packet should be forwarded. In cases where packets are received from the data network 102 over multiple low bandwidth ports, the aggregate input bandwidth can be split to multiple devices in the packet switch 104 by dividing the number of incoming ports evenly among the packet switch components. For example, to achieve 40 Gb/s of full-duplex packet buffering and forwarding through the packet switch 104, four 10 Gb/s full-duplex buffer engines can be utilized. However, when there is a single, high bandwidth (e.g., 40 Gps physical interface) incoming interface from the data network 102, incoming bandwidth into the packet switch 104 is split among multiple buffering chips using a byte-slicing technique. Thus, the packet switch 104 may provide optimal performance both in the case where a large number of physical ports are aggregated over a single packet processing pipeline, as well as where a single high-speed interface (running at 40 Gb/s) needs to be supported, for example.

The packet switch 104 may support multiple types of packet services, such as for example L2 bridging, IPv4, IPv6, MPLS (L2 and L3 VPNs), on the same physical port. A port interface module in the packet switch 104 determines how a given packet is to be handled and provides special “handling instructions” to packet processing engines in the packet switch 104. In the egress direction, the port interface module frames outgoing packets based on the type of the link interface. Example cases of the processing performed in the egress direction include: attaching appropriate SA/DA MAC addresses (for Ethernet interfaces), adding/removing VLAN tags, attaching PPP/HDLC header (POS interfaces), and similar processes. In depth packet processing, which includes packet editing, label stacking/unstacking, policing, load balancing, forwarding, packet multicasting supervision, packet classification/filtering and other, occurs at an ingress header processor engine in the packet switch.

When the aggregate bandwidth of all incoming ports at the packet switch 104 is high, the resources of the packet switch 104 can be optimized to minimize hardware logic, minimize cost and maximize packet processing rate. For example, data can be split over multiple buffering devices in the packet switch 104 through inverse multiplexing. Inverse multiplexing will send some packets to each of the available buffering devices in the packet switch in a load-balancing manner. A data stream also can be divided into multiple concurrent streams that are transmitted at the same time across separate channels in the packet switch 104 to available buffering devices, and are then reconstructed at a port interface into the original data stream for transmission back into the network. Each buffering device within the packet switch 104 will store a piece of the data stream, and upon reconstruction of the stream, each buffering device will need to access the appropriate portion of its stored data so as to reconstruct the stream into its original form. To do so, a view of memory seen by one buffering device should match that seen by the other devices.

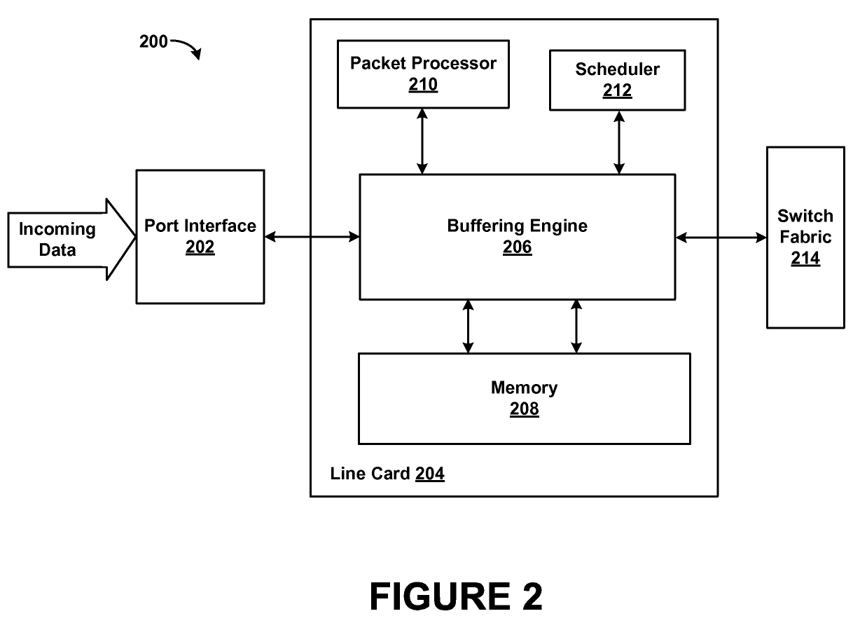

FIG. 2 illustrates a block diagram of one example of a packet switch 200. The packet switch 200 includes a port interface 202 coupled through a mid-plane to a packet processing card or a line card 204. The packet switch 200 may include any number of port interface modules and any number of line cards depending on a desired operating application of the packet switch 200. Multiple port interface modules and line cards can then be connected through a switch fabric 214, which all may all be included on one chassis, for example.

The line card 204 processes and buffers received packets, enforces desired Quality-of-Service (QoS) levels, and transmits the packets back to the network. To do so, the line card 204 includes a buffering engine 206 and memory 208. The buffering engine 206 may be implemented utilizing ASIC technology, for example. This approach achieves a degree of flexibility and extensibility of the switch as it allows for continuous adaptation to new services and applications, for example.

The line card 204 further includes a packet processor 210 and a scheduler 212. The packet processor 210 informs the buffering engine 206 how to modify the received packets, while the scheduler 212 informs the buffering engine 206 when to retrieve the pieces of received packets to be sent out to the switch fabric 214. In turn, the switch fabric 214 sends the packets between line cards.

The packet switch 200 may implement a packet editing language where header/data bytes may be added, deleted, or altered from an originally received packet data stream. The decision of how to modify and what needs to be modified is performed by the packet processor 210. The packet processor 210, in addition to being able to perform specific types of packet header editing, also instructs the buffering engine of additional editing that needs to occur.

Within the packet switch 200, in depth packet processing (which includes packet editing, label stacking/unstacking, policing, load balancing, forwarding, packet multicasting supervision, packet classification/filtering and other) occurs within the line card 204. The line card 204 may operate on an internal packet signature, which may be the result of packet pre-classification that occurred in the port interface module 202, as well as the actual header of the packet under processing, for example.

In the ingress direction, the port interface module 202 receives a data packet and checks for L1/L2/L3 packet correctness (i.e., CRC checks, IP checksums, packet validation, etc.). Once packet correctness is established, the port interface module 202 can perform a high-level pre-classification of the received data packet, which in turn, may determine a type of processing/handling for the data packet. Since the packet switch 200 supports multiple types of packet services, such as for example L2 bridging, IPv4, IPv6, MPLS (L2 and L3 VPNs), on the same physical port, the port interface module 202 determines how a given packet is to be handled and provides special “handling instructions” to packet processing engines, such as the buffering engine 206.

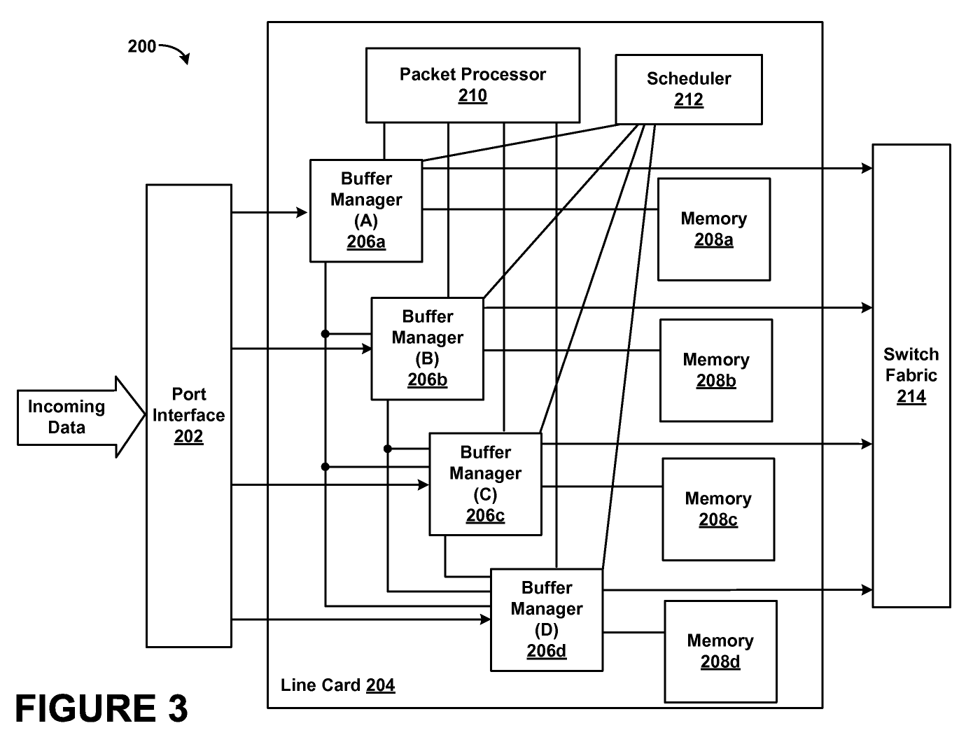

FIG. 3 illustrates a more detailed block diagram of the example of the packet switch 200. As shown, the buffering engine includes buffer manager devices (A)-(D) 206a-d, each of which is coupled to a memory 208a-d. Each of the buffer manager devices (A)-(D) 206a-d is coupled to the other buffer manager devices and to both the packet processor 210 and the scheduler 212.

The packet switch 200 utilizes a method whereby the aggregate bandwidth received from the network over one or more incoming ports is sliced on a byte-by-byte basis to be transferred concurrently to the multiple buffer managers. Such a method is important when the aggregate bandwidth of the one or more incoming ports exceeds the bandwidth capabilities of an individual buffer manager device, for example. By utilizing a byte-slicing based approach, multiple buffer manager devices form a single high bandwidth interface to the switch fabric 214.

The port interface 202 may receive packets from one or more sources, and for each received packet, an address signature is appended to a portion of the packet that is sent to the buffer managers (A)-(D) 206a-d. Information indicating an incoming port is included as part of the signature. It may be desirable to have multiple incoming interfaces for each buffer manager, coming from the port interface 202, to reduce the signaling requirement on the port interface. For example, if there are 40 Gigabit Ethernet ports being received at the port interface 202, there may be four instances of the port interface, each serving 10 ports. Each of these port-interface groups sends byte-sliced data to all four buffer managers. In effect, each buffer manager receives the byte-sliced data for all 40 Gigabit Ethernet ports but over multiple physical interfaces. This method requires a consistent interleaving of the packets received over the separate physical interfaces on each buffer-manager.

Byte slicing is accomplished by dividing each received data packet into N pieces, and forwarding each piece to a different buffer manager device. An N-level slicing is accomplished by forwarding exactly 1/Nth of each data packet to a given buffer engine. Thus, an N-level slicing requires the use of N buffer management engines. Therefore, more or fewer buffer engines may be included within the line card 204. Furthermore, the slicing technique forwards bytes located in a specific location within the packet to the same buffer management engine. For example, a byte at location k within a packet is sent to a buffering engine identified by the following equation:

destination buffer engine=k mod N

so that, for example, using a 4-level slicing method, bytes 2, 6, 10, etc. (bytes at location 2, 6, 10), will all be sent to the second buffer manager or buffer manager 206b. Note that while in this example the mapping of packet payload to buffer management engines is performed at byte-level, other forms of packet payload partitioning and mapping to buffer management engines may be utilized as well. For example, packet payload slicing may be done at a word level (e.g., a word is a group of 4 bytes). For more information regarding the byte-slicing technique, the reader is referred to U.S. patent application Ser. No. 11/322,004, filed Dec. 29, 2005, entitled “Method and System for Byte Slice Processing of Data Packets at a Packet Switching System,” the contents of which are herein incorporated by reference as if fully set forth in this description.

The buffer managers (A)-(D) 206a-d will process the individual bytes that are sent to each of them. An error mechanism is used for protection and alignment of sliced bytes between the buffer managers (A)-(D) 206a-d and can be achieved by implementing a cyclic redundancy code (CRC) to protect data transmitted on each slice. The sliced data can be discarded upon detection of a CRC error.

A “frame structure” can be introduced at the interfaces that send the byte-sliced data to the multiple buffer managers (A)-(D) 206a-d, the port-interface 202 and the packet processor 210. As an example, every eight clock-cycles of data could be considered as a frame. Extra signals are introduced to indicate a start of a frame as well as to communicate a checksum or CRC computed over the data in the frame. By keeping the frame a reasonable size, requirements of precise clock-cycle synchronization are reduced between the signaling to each buffer engine. The signaling of errors between the multiple slices can then be accomplished in a duration significantly less than the frame time.

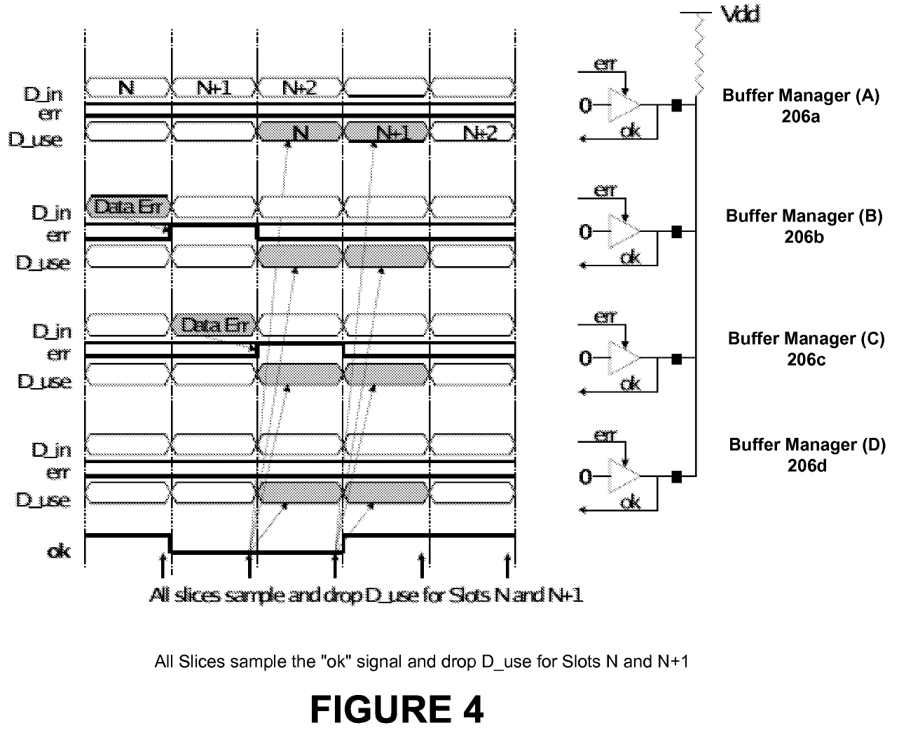

FIG. 4 illustrates a timing diagram demonstrating one example of a CRC protection that may be used by the buffer managers (A)-(D) 206a-d. A data packet is divided into N bytes, in which a first byte is sent to buffer manager (A) 206a, a second byte is sent to buffer manager (B) 206b, a third byte is sent to buffer manager (C) 206c, and a fourth byte is sent to buffer manager (D) 206d. This procedure will continue until all bytes of the packet have been distributed.

Upon reception of a frame, a buffer manager will check for an error by verifying a CRC bit within the frame. In the example illustrated in FIG. 4, buffer manager (B) 206b notes an error in frame N, and buffer manager (C) 206c notes an error in frame N+1. If any one of the buffer managers finds an error within its respective frame, then all slices drop the frame corresponding to the faulty time slot. For example, when an error bit is low, a byte slice within a previous time slot contained an error and will be dropped. Also, the data frames at the remaining buffer managers within the previous time slot will also be dropped.

In FIG. 4, the use of a single connection “ok” to distribute the notifications to all the buffer managers reduces a number of wires used to communicate the error on the interface. In the absence of errors, a tri-state driver on each buffer manager is turned off and the shared line is pulled up to a high to signal no errors. When an error is detected at the end of a frame, the shared line is driven low and all the other buffer managers can sense the low-level and interpret it as an error condition, and drop the relevant frame. Due to the requirement of having error-detection on all interfaces that use byte-slicing, the number of signals required to communicate errors is optimized. An alternate implementation of having a wire communicate the error on one slice to other slices requires the use of N signals per interface, while the shared implementation shown in FIG. 4 reduces the overhead to one wire per interface.

After validating all byte slices at all the buffer managers, the byte slices can be processed and stored. The data may be stored internally in the buffer manager or alternately in the external memory 208a-d. Once the packet is scheduled to be transmitted back into the network, the bytes of data comprising the packet need to be reconstructed in the same order as received so as to transmit the packet in its original form. Thus, each buffer manager device correlates memory locations of stored bytes of packets together so as to remain synchronized.

One way to handle packet memory addressing is for each buffer manager to independently manage the addresses that the buffer manager uses to store the packets as a linked list. The overall packet is then addressed as a concatenation of the start addresses on each slice. However, using this method, the size of the packet-address would be N times larger than if identical start address and identical sequence of addresses for the linked lists were used by the buffer managers. The independent addressing also puts an increased demand on the internal memory required to manage the free-pages in external memory since the similar work of managing occurs N times, once on each buffer-manager.

With synchronized addressing, there may be an added burden of synchronization, but the advantage of having each buffer-manager responsible for the free-page management for a fraction of external memory reduced the internal memory required on each buffer manager by a factor of 1/N. Synchronized addressing also reduces a size of the packet-descriptor by a factor of 1/N. Such effects have impacts on a design of the scheduler 212 since the interface bandwidth is reduced by a factor of 1/N and external SRAM required to store the packet descriptors is also reduced by a factor of 1/N.

Within the packet switch 200, since separate devices are responsible for storing a part of a data word, a view of memory addresses seen by one device matches that seen by the others. Each buffer manager (A)-(D) 206a-d uses the same order of memory addresses to write data so that the bytes of data are stored as a linked-list of pages. Maintaining the same sequence of page requests and sequence of free-page addresses to which to write these pages ensures consistent addressing on the N-slices.

When multiple byte-slice packet interfaces are received at a buffer-manager (e.g., such as when a line card with 40 Gigabit ports is divided into 4 units of 10 physical ports), the received data is interleaved in an identical manner to ensure that a consistent sequence of pages is written. One buffer-manager, e.g., 206a, is designated as a master and transmits an interleaving sequence for the multiple interfaces to the other buffer-managers 206b-d. The sequence information should be protected from corruption as the information is signaled from the master to the others because any mismatch between the slices will result an unsynchronized structure of the packet. An error-correcting code can be employed so that occasional errors can be corrected. When un-correctable errors are detected, the buffer-managers are then re-synchronized.

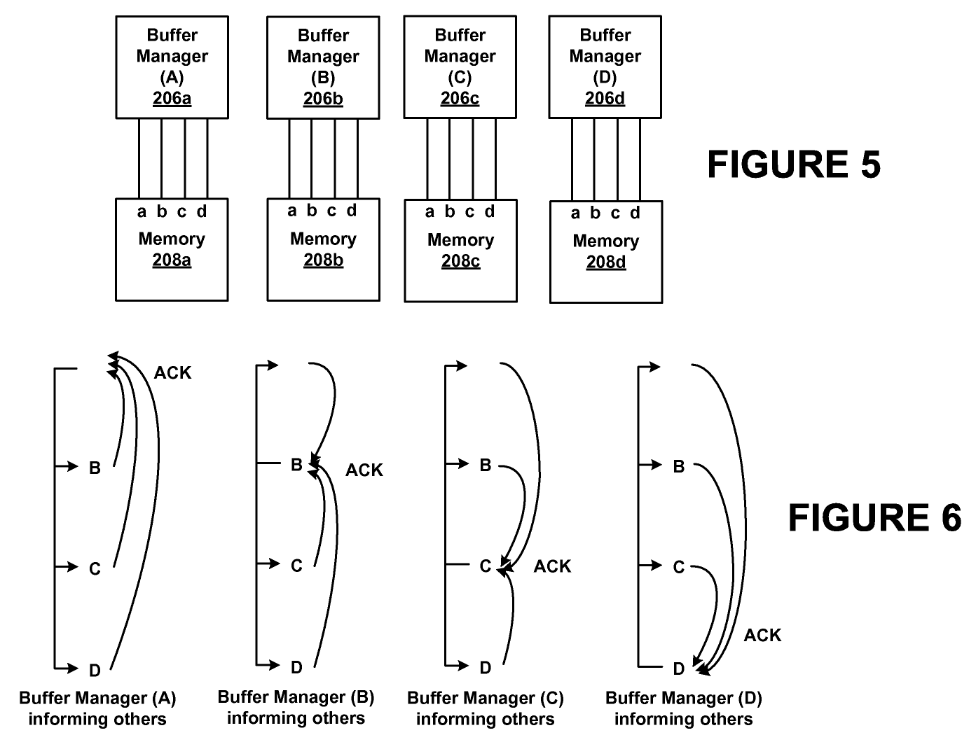

FIG. 5 is a diagram illustrating how the page addressing to be used for storing the bytes of the final combined packet stream within the buffer managers (A)-(D) is synchronized. Synchronized addressing can efficiently use the internal memory on each buffer manager to track the use of free-pages in a part of external memory. As an exemplary implementation, consider the case where each memory 208a-d has four channels to which data can be written, namely channels a-d. Each buffer manager 206a-d is responsible for maintaining addressing of one memory channel. In particular, buffer manager (A) 206a manages the address locations of memory channel a, buffer manager (B) 206b manages the address locations of memory channel b, buffer manager (C) 206c manages the address locations of memory channel c, and buffer manager (D) 206d manages the address locations of memory channel d. The mapping of buffer managers to parts of the external memory can use any other scheme, not just one based on having separate physical channels.

Each buffer manager (A)-(D) 206a-d will communicate with each other to inform the other buffer managers on what channel to store bytes of the same packet so as to keep the memory system organized. This is illustrated in FIG. 6. Buffer manager (A) 206a will send a message to each of buffer managers (B)-(D) 206b-d informing them of free addresses to which to write data over channel a, within their respective memories. Each message has a sequence identifier and a CRC checksum that allows the receiving buffer manager to determine if the message is received correctly and to determine the buffer manager's order in the sequence of messages. After receiving the signal, each buffer manager will send an acknowledgement signal back to buffer manager that originated the message, in this case (A). If the sending buffer manager does not receive an acknowledgement in a fixed time amount, the sending buffer manager retransmits the message to ensure that others eventually receive the message. Similarly, buffer managers (B)-(D) 206b-d send messages to each of the other respective buffer managers informing them of free addresses to which to write data over channels b-d, respectively. Each buffer manager uses a fixed sequence of the messages from itself and the others to determine to which addresses to write. In this manner, all the buffer managers (A)-(D) 206a-d may operate together and appear as one unit since each buffer manager will write data of the same packet at the same address locations within each of memories 208a-d.

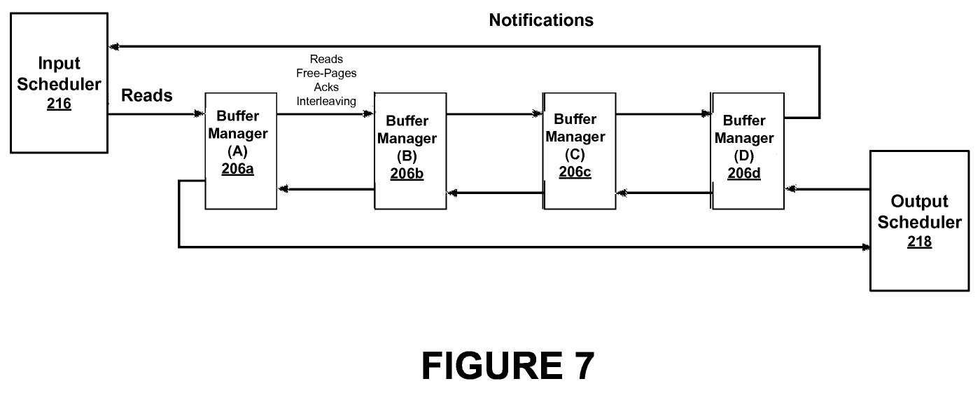

The exchange of messages may use dedicated interfaces that interconnect the buffer managers. In another embodiment, since each buffer manager communicates the same message to the others, a two counter-rotating ring interconnect can be used to transmit the messages and acknowledgments between the buffer managers, as shown in FIG. 7. Also, as shown in FIG. 7, the scheduler 212 in the line card 204 may include an input scheduler 216 and an output scheduler 218. On the top ring, the last buffer manager 206d notifies the input scheduler 216 of the packet descriptor and the packet length. Also, on the top ring, the input scheduler 216 sends the read requests to buffer managers 206a-d. Thus, same output pins can be used in two modes on buffer managers 206a-c to propagate the read requests downstream and on the last buffer manager 206d to send the notifications to the scheduler. This reduces the number of pins on each buffer manager.

The bottom ring is used to communicate the read requests on the egress direction from the output scheduler 218 as well as the notifications from the last buffer-manager on that ring 206a to the egress scheduler. The signals in the counter-rotating rings are also used to transmit the free-page address messages as well as the acknowledgement messages shown in FIG. 6.

The read notifications from the ingress and egress schedulers also carry a sequence number and a CRC checksum to ensure their integrity. Read requests in error are discarded and an error packet is inserted in the outgoing stream so that a device that receives the packet stream from individual buffer managers can re-align the packets. In one embodiment, on the ingress side, “super-frames” are used to carry several packets towards the switch fabric. With a read request in error, the frame is filled with an error-pattern so that subsequent packets in the frame are discarded and the error propagation is limited to the duration of a frame. This is helpful because when a read request is in error, it is unclear how much data to insert so that subsequent packets are aligned. Another alternative is to drop packets in the frame. On the egress direction, from the line card to the port-interface, a running sequence can be used and gaps in the received sequence from the buffer managers allows the port-interface module to drop packets corresponding to missing sequence numbers, for example.

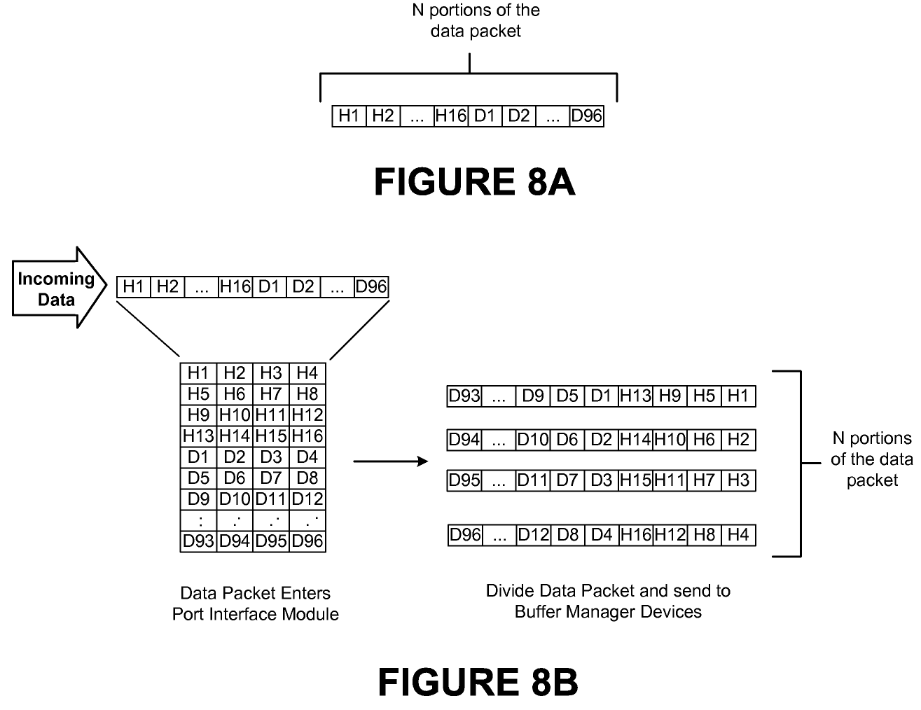

FIGS. 8A and 8B illustrate examples of dividing received data packets for storage within memory as directed by the buffer managers (A)-(D) 206a-d. As shown in FIG. 8A, a data packet may be divided into portions, so that each portion includes the same amount of data.

In this example, the data packet is byte-sliced so that each portion contains a byte of data. In this manner, the data packet is divided into portions header 1 (H1), header 2 (H2) . . . data 1 (D1), data 2 (D2), and so forth. Each buffer manager (A)-(D) 206a-d will receive portions of the data packet. For example, buffer manager (A) 206a will receive H1 and each subsequent 4th portion, buffer manager (B) 206b will receive H2 and each subsequent 4th portion, buffer manager (C) 206c will receive H3 and each subsequent 4th portion, and buffer manager (D) 206d will receive H4 and each subsequent 4th portion.

Alternatively, as shown in FIG. 8B, a portion of a data packet may be groups of data that result after dividing the data packet. In this manner, buffer manager (A) 206a will receive the first portion (H1, H5, . . . , D1, D5, . . . , and D93), buffer manager (B) 206b will receive the second portion (H2, H6, . . . , D2, D6, . . . , and D94), buffer manager (C) 206c will receive the third portion (H3, H7, . . . , D3, D7, . . . , and D95), and buffer manager (D) 206d will receive the fourth portion (H4, H8, . . . , D4, D8, . . . , and D96).

After any necessary processing, buffer managers (A)-(D) 206a-d will store their respective portions of the data packet. The portions should be stored at certain locations within memory so that when the portions are retrieved, the data packet can be put back together properly. Thus, each first portion of the data packet received by each buffer manager can be stored at the same location in the respective memory for each buffer manager. For example, each buffer manager can store the first portion of the data packet that it receives at Address location #1 of channel A in its respective memory, and the second portion of the data packet that it receives at Address location #2 of channel A, and so on. Alternatively, the second portion could be stored at Address location #1 of channel B, and so on. The portions of the data packet can be stored at any location within the memory of the buffer managers so long as each buffer manager stores a corresponding portion of the data packet in a corresponding location. In this manner, each buffer manger will store a corresponding portion of the data packet at the same locations in its memory.

To do so, as discussed above, buffer manager (A) 206a will manage Address locations of memory channel A, buffer manager (B) 206b will manage Address locations of memory channel B, and so on. The buffer managers (A)-(D) 206a-d can then inform each other of the specific address location at which to store a portion of the data packet.

Within exemplary embodiments, each buffer manager has knowledge of each others memory so that incoming data packets, which are divided based on a desired technique, may be stored consistently within individual memories.

It should be understood that the processes, methods and networks described herein are not related or limited to any particular type of software or hardware, unless indicated otherwise. For example, operations of the packet switch may be performed through application software, hardware, or both hardware and software. In view of the wide variety of embodiments to which the principles of the present embodiments can be applied, it is intended that the foregoing detailed description be regarded as illustrative rather than limiting, and it is intended to be understood that the following claims including all equivalents define the scope of the invention.

What is claimed is:

1. A packet switch comprising:
a port interface module for receiving a data packet, the port interface module operable to divide the data packet into n portions, such that each subsequent portion includes every subsequent nth group of the data packet;
memory modules having multiple locations to which to write data; and
buffer manager devices coupled to the port interface module, each buffer manager device coupled to a respective memory module, and each buffer manager device receiving at least one of the n portions of the data packet from the port interface module and storing the portion at a location in the respective memory module to which the buffer manager device is coupled,
wherein each buffer manager device stores received portions of the data packet at locations in the respective memory module to which the buffer manager device is coupled using the same order of memory addresses so as to store the received portions of the data packet in a synchronized manner.

2. The packet switch of claim 1, wherein each buffer manager device stores a first received portion of the data packet at a first location in the respective memory module to which the buffer manager is coupled, and stores a second received portion of the data packet at a second location in the respective memory module to which the buffer manager is coupled, and so on.

3. The packet switch of claim 1, wherein each buffer manager device stores received portions of the data packet in the order received and using the same order of memory addresses.

4. The packet switch of claim 1, wherein each memory module includes multiple channels to which to write data, and wherein each buffer manager device determines memory addresses to which to write data for one of the channels and informs the other buffer manager devices of the memory addresses to maintain synchronization of storage of data.

5. The packet switch of claim 1, wherein the port interface module includes multiple port interfaces each of which receives data packets, and wherein each data packet from each port interface is divided and sent to the buffer manager devices, wherein one of the buffer manager devices is a master device and transmits an interleaving sequence to direct storing of the portions of the data packets to the other buffer manager devices.

6. The packet switch of claim 1, wherein each buffer manager device checks for errors within received portions of the data packet by verifying a cyclic redundancy code (CRC) signature within received portions.

7. The packet switch of claim 6, wherein if any of the buffer manager devices identifies a time slot containing an error within a received portion of the data packet, all buffer manager devices drop the received portion of the data packet corresponding to the identified time slot.

8. The packet switch of claim 1, wherein the buffer manager devices retrieve stored portions of the data packet in a synchronized manner so that the data packet is reconstructed in the same order as received to be transmitted to the port interface module.

9. A method for storing data packets received at a packet switch comprising:
receiving a data packet into a port interface module of the packet switch;
dividing the data packet into multiple portions;
sending the multiple portions of the data packet to buffer manager devices, wherein each buffer manager device stores data in a respective memory having multiple channels to which to write data;
a given buffer manager device informing the other buffer manager devices of a memory address to which to write data on a given channel in memory; and
each buffer manager device storing received portions of the data packet at the memory addresses of the given channels in the buffer manager device's respective memory.

10. The method of claim 9, wherein each buffer manager device is responsible for maintaining addressing of one memory channel.

11. The method of claim 9, wherein sending the multiple portions of the data packet to buffer manager devices comprises sending a byte of data from the data packet at location k within the data packet to a buffer manager device identified by the following equation:
destination buffer manager device=k mod N
where N is the number of buffer manager devices.

12. The method of claim 9, wherein the given buffer manager device informing the other buffer manager devices of the memory address to which to write data on the given channel in memory comprises informing the other buffer manager devices to store a first received portion of the data packet at a first location of a first memory channel, informing the other buffer manager devices to store a second received portion of the data packet at a first location of a second memory channel, and so on.

13. The method of claim 12, wherein each buffer manager device storing received portions of the data packet at the memory addresses of the given channels in the buffer manager device's respective memory comprises each buffer manager device storing received portions of the data packet in the order received and using the same order of memory addresses.

14. The method of claim 9, furthering comprising storing the multiple portions of the data packet at locations in the respective memory of the buffer manager device using the same order of memory addresses so as to store the received portions of the data packet in a synchronized manner.

15. The method of claim 9, further comprising the other buffer manager devices acknowledging receipt of the memory address.

16. A method for storing data packets received at a packet switch comprising:
receiving a data packet into a port interface module of the packet switch;
dividing the data packet into multiple portions;
sending the multiple portions of the data packet to buffer manager devices, wherein each buffer manager device stores data in a respective memory having multiple channels to which to write data;
each buffer manager device maintaining addressing of one memory channel;
utilizing a ring transmission technique to indicate memory address information to which to write data for each memory channel between the buffer manager devices; and
each buffer manager device storing received portions of the data packet in the memory channels at the indicated memory addresses within the buffer manager device's respective memory.

17. The method of claim 16, wherein each buffer manger device is in communication with a first and a second neighboring buffer manager device, and the method further comprising each buffer manager device receiving memory address information from the first neighboring buffer manager device, the memory address information indicating a memory address at which to store data within the one memory channel for which the first neighboring buffer manager device maintains.

18. The method of claim 17, wherein utilizing the ring transmission technique to indicate memory address information to which to write data for each memory channel between the buffer manager devices comprises each buffer manager device informing their respective second neighboring buffer manager device of a memory address at which to store data within the one memory channel for which the buffer manager device maintains and the buffer manager device also passing the memory address information received from the first neighboring buffer manager device to the second neighboring buffer manager device.

19. The method of claim 18, further comprising each buffer manager device acknowledging receipt of the memory address at which to store data within the one memory channel for which the buffer manager device maintains and the memory address information received from the first neighboring buffer manager device.

20. The method of claim 16, furthering comprising storing the multiple portions of the data packet at locations in the respective memory of the buffer manager device using the same order of memory addresses so as to store the received portions of the data packet in a synchronized manner.
